(19) United States
(12) Patent Application Publication
(10) Pub. No.: US 2007/0117442 A1
(43) Pub. Date: May 24, 2007

(54) Guard rail base and guard rail support

(76) Inventor: Jonny Jonathan Melic, Burlington (CA)

Correspondence Address: GOWLING, LAFLEUR HENDERSON LLP, ONE MAIN STREET WEST, HAMILTON, ON, L8P 4Z5, CA

(21) Appl. No.: 11/600,805

(22) Filed: Nov. 17, 2006

(30) Foreign Application Priority Data
Nov. 18, 2005 (CA) 2527250

(51) Int. Cl. H01R 13/62

(52) U.S. Cl. 439/328

(57) ABSTRACT

A guard rail base has a lumber receiving socket in which a transversely extending notch pin is rotatably mounted to engage a piece of lumber upon rotation thereof to cut a notch in the lumber and secure the lumber to the socket. The socket is coupled to a base member that includes a nail guide having a plurality of spaced nail guiding apertures oriented to receive nails from opposite directions so that the nails may bite into an underlying wood deck. Openings in the base member are also provided to receive anchors for a concrete deck. A guard rail base is also provide with an integral post to replace the socket. The post has brackets to receive and locate a transversely disposed removable barrier such as a wood rail or fence.

### FIELD OF INVENTION

This invention relates to safety barriers used in the construction of high-rise and other buildings, and more particularly, relates to a base for a guard rail of the kind which is constructed from lumber.

### BACKGROUND OF THE INVENTION

The construction of modem high-rise buildings usually requires temporary barriers to be erected on the building perimeter for all floors as the work progresses until exterior walls are in place. The barriers must be secure to ensure the safety of the persons working at the construction site and preferably, the barriers should be easy to install and to remove for reuse. Conveniently, guard rails are constructed from lumber which is inexpensive and readily available in the form of posts having standard dimensions of two inches by four inches (2×4). Transverse wood rails are nailed to the posts to complete the assembly of the guard rail. The support surface on which the guard rail is erected may be a concrete deck but may also be a wood form forming part of a shoring platform to provide a base for poured concrete.

In known devices, the lumber pieces comprising upright posts for the guard rail are secured to the support surface using a base fabricated from steel which has a socket dimensioned to receive the lumber and extending from one side of a planar base member. Both the socket and base member are apertured to receive threaded wood fasteners for securing the base to the lumber and to the support surface respectively. Where the support surface is concrete, a wood base is first secured to the concrete so that the base member can be screwed to the wood base. Preferably, the socket is formed at one end of the support base so that the base is more stable and cannot readily be pried away from the support surface.

An object of this invention is to provide a base which is easily installed and removed for reuse and a more convenient guard rail support.

### SUMMARY OF THE INVENTION

In accordance with this invention, there is provided a base for a vertical post forming part of a guard rail system, the base having an open socket dimensioned for receiving the post and a base member. The socket has a transversely extending notch pin rotatably mounted between opposite sides of the socket and adapted to engage the post upon rotation thereof to cut a notch in the post. A locking lever fixed to the notch pin is provided to rotate the pin into and out of engagement with the post.

The invention also provides a nail guide in the base member which has a plurality of nail guiding apertures oriented to receive fasteners from opposite directions so that the fasteners may bite into an underlying support surface.

In accordance with another aspect of the invention, the base member is provided with an integral post to replace the socket, the post having at least one bracket vertically spaced from the base and adapted to receive and locate a transversely disposed removable barrier.

### BRIEF DESCRIPTION OF THE DRAWINGS

In order that the invention can be more clearly understood, a preferred embodiment is described below with reference to the accompanying drawings, in which:

FIG. 1 is a perspective view of a guard rail system with a base in accordance with the invention assembled on a deck;

FIGS. 2a to 2c are side elevation views of the base in accordance with the invention showing various positions of a locking lever and partly cut away to show a notch pin;

FIG. 3 is a top plan view of the base in accordance with the invention;

FIG. 4a is a side elevation view of a post of lumber notched by the invention (exaggerated for illustration);

FIG. 4b is a perspective view of the post of FIG. 4a;

FIG. 5 is a perspective view of the base being installed on a wood deck;

FIG. 6 is a side elevation view, partly sectioned, showing the nail entry position into the base through a wood deck;

FIG. 7 is a similar view to FIG. 5 showing the base being installed on a concrete deck;

FIG. 8 is a perspective view of an alternative embodiment of the invention showing a post with support brackets formed integrally with the base;

FIG. 9 is a perspective view showing a pair of posts according to the invention in use to support a removable barrier in the form of rails, and

FIG. 10 is a similar view to FIG. 9 showing a pair of posts according to the invention in use to support a removable barrier in the form of a fence.

### DESCRIPTION OF PREFERRED EMBODIMENTS WITH REFERENCE TO DRAWINGS

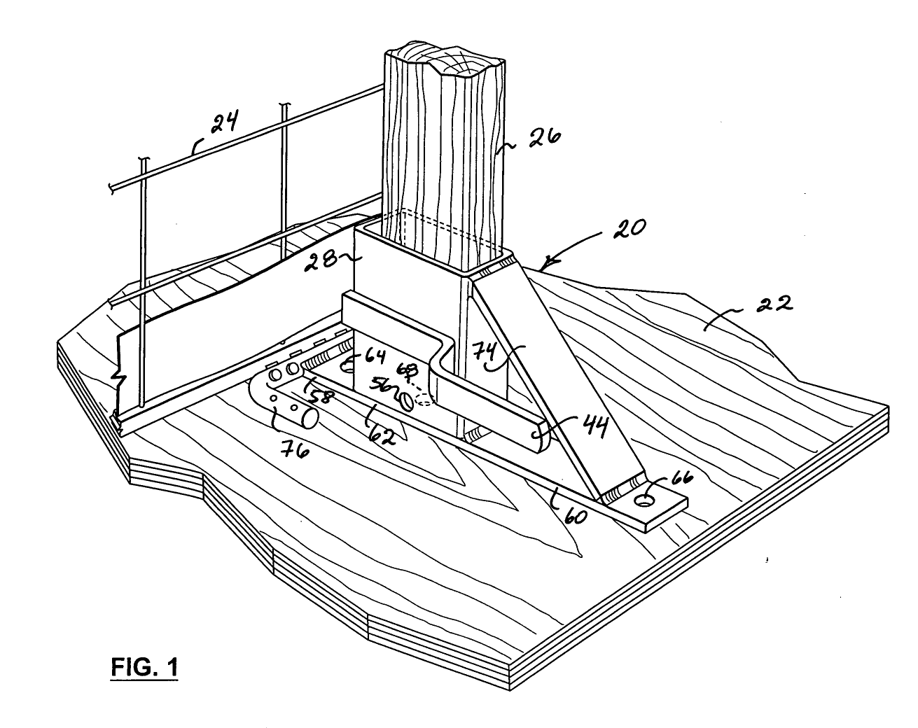

A guard rail system coupled to a base 20 in accordance with the invention is shown in FIG. 1 assembled on a wood deck 22. The guard rail consists of a safety fence 24 mounted on the interior side of a building under construction and braced by a support post in the form of a piece of lumber 26 disposed on the exterior side of the building. Conveniently, the piece of lumber 26 is made of soft wood such as pine and has conventional dimensions of 2 inches by 4 inches (2×4). The base 20 has an upwardly extending socket 28 which is of rectangular cross-section and is dimensioned to receive the piece of lumber 26. It will be noted that the socket 28 is somewhat larger than the piece of lumber 26 and in this case is approximately 5 inches long.

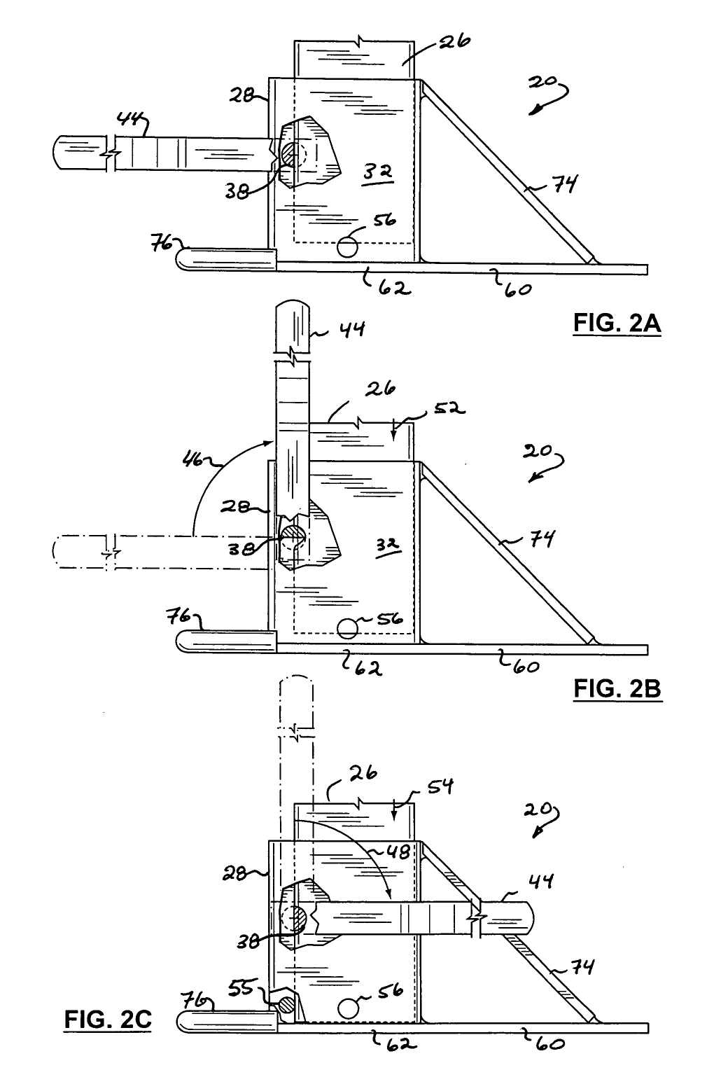

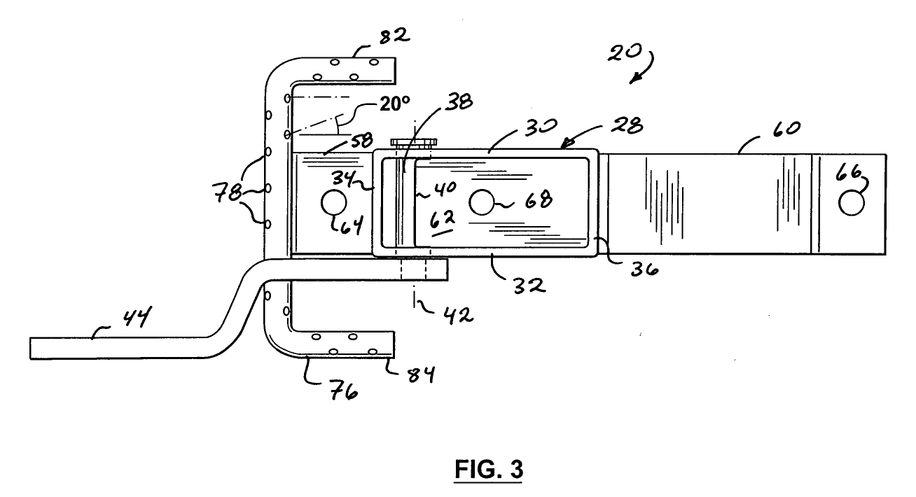

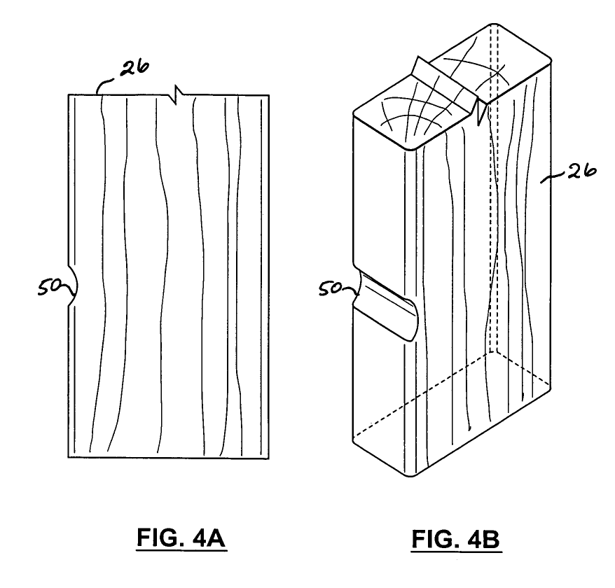

As will be seen in the top plan view of FIG. 3, the socket 28 is formed by two pairs of opposite sides 30, 32 and 34, 36. Between opposite sides 30, 32 there is a transversely extending notch pin 38 which is rotatably mounted at one end of the socket. It will be noted that the notch pin 38 is asymmetric and has a flat side 40 which is aligned with an axis of rotation for the pins 38 as indicated by reference numeral 42. A locking lever 44 is fixed to the notch pin 38 on the exterior of the socket 28 and is adapted to rotate the notch pin 38 into and out of engagement with the piece of lumber 26 as illustrated by the drawings of FIGS. 2a, 2b and 2c. It will be appreciated that such rotation of the locking lever 44 as indicated by arrows 46, 48 will cause the notch pin to carve a notch 50 into the lumber as shown in FIGS. 4a and 4b where the notch 50 is somewhat exaggerated for purposes of illustration. Simultaneously with such engagement into the lumber piece 26 of the notch pin 38, the piece of lumber 26 will be moved downwardly as indicated by arrows 52, 54 so as to be seated into the socket 28. A stop pin 55 (FIG. 2c) disposed inside the socket 28 beneath the notch pin operates to limit displacement of the post 26 inside the socket. Conveniently, a viewing aperture 56 is provided in one of the sides 32 for visual inspection of the socket 28 and to ensure that the piece of lumber 26 is properly seated. The viewing aperture 56 will also operate to drain any rain water from the socket 28 thereby minimizing the likelihood of the piece of lumber 26 becoming rotten from excess moisture build up in the socket.

The socket 28 extends from one side of a base member and the base member is apertured to receive fasteners to secure the base to a support surface, as will be described. Conveniently, the socket 28 is formed from a tubular steel section which is welded at one end to a bottom plate extending forwardly and rearwardly from opposite sides 34, 36 to define a rearward wing 58 and a forward wing 60 and a closed bottom 62 for the socket 28. Each section of the bottom plate is apertured with apertures 64, 66, 68 respectively for receiving anchors 70 to secure the base 20 according to the invention to a concrete deck 72 as illustrated in FIG. 7. In order to increase stability and rigidity of the base 20, a transverse brace 74 extends between the top of the socket 28 and a forward end of the forward wing 60. Conveniently, a security cable (not shown) may be threaded through the opening formed by the brace 74 and the socket 28 to connect a shipment of guard rail bases made in accordance with the invention and to discourage pilfering.

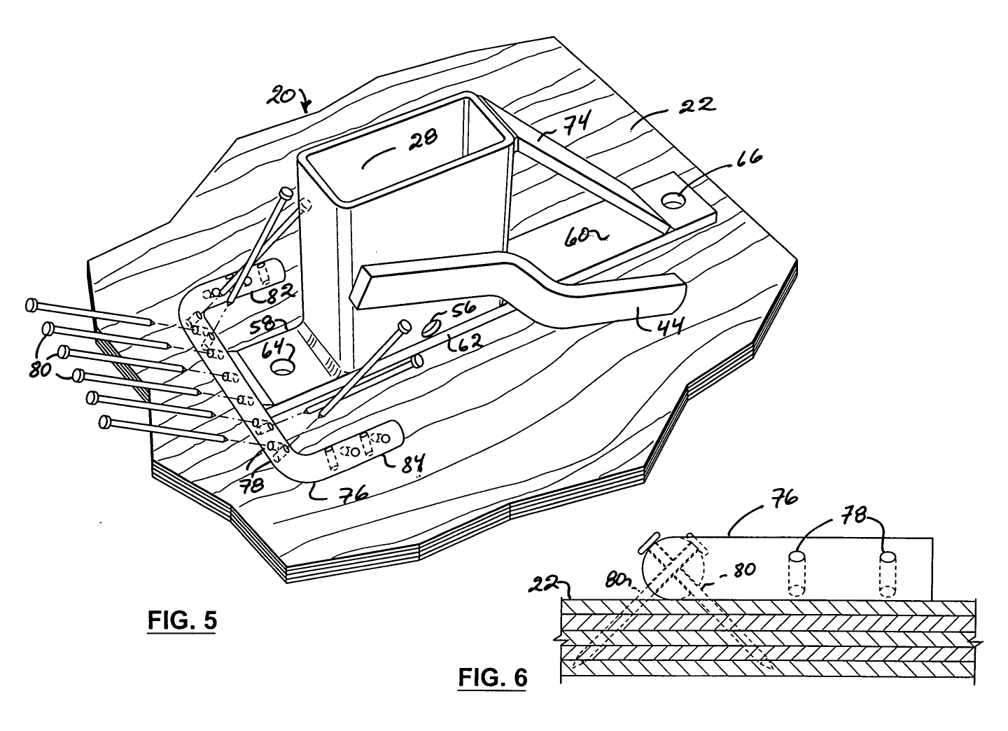

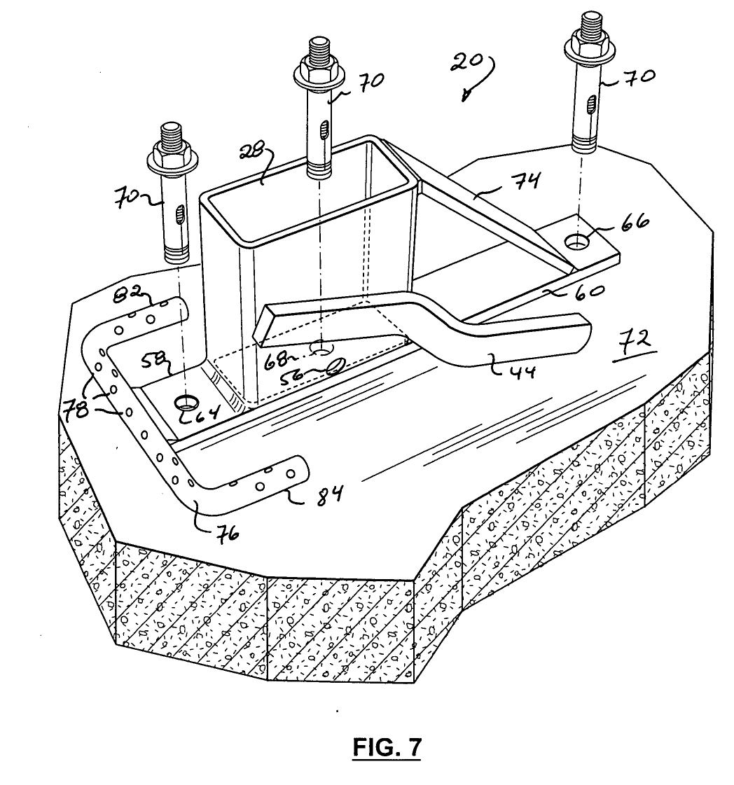

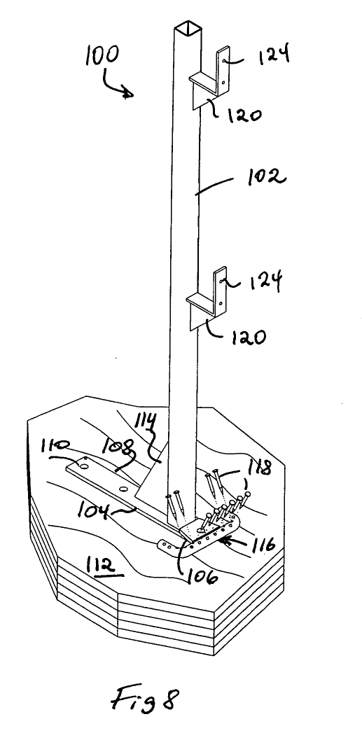

It will be observed that the locking lever 44 has a free end which is spaced from the brace 74 by a bend in the lever of sufficient width to accommodate a user's hand between the lever and the brace and socket arrangement. The rearward wing 58 spaces a nail guide identified by reference numeral 76 which is used to secure the base to a wood deck 22 as illustrated by FIGS. 5 and 6. The nail guide is in the form of a steel rod bent into a C-shaped configuration and having a plurality of nail guiding apertures 78 spaced from each other along the length of the rod and oriented to receive nails 80 from opposite directions so that the nails may bite into the underlying wood deck 22. The number of nails used will in part depend on the condition of the wood deck as fewer nails would be required for a new plywood underlay, for example. The nail guiding apertures 78 are sufficiently spaced from each other that the underlying wood deck is not shredded and will continue to hold the nails as illustrated schematically in FIG. 6. In addition, the nail guiding apertures are oriented to receive the nails 80 at an angle of 30 to 60 degrees relative to the support surface, an angle of 45 degrees having been found to be adequate to allow the nails to penetrate into the wood and also withstand accidental prying which would loosen the guard rail base 20 from the deck. The nail guiding apertures 78 nearest to the rearward wing 58 of the bottom plate are also angled at 20° as seen in the plan view of FIG. 3 in order to provide sufficient clearance between the nail guide 76 and the socket 28 for a hammer.

In most applications, eight nails will be sufficient but additional nail guiding apertures 78 are provided should the need arise to use more nails. Still further security is provided by the nail guiding apertures 78 formed in lateral nail guide portions 82, 84 which extend parallel to the rearward wing 58. Conveniently, the lateral nail guide portions 82, 84 may be used as a carrying handle for manually carrying the base 20 at a job site.

In some applications, it may be desirable to use other fasteners such as wood screws instead of nails.

In use, pieces of lumber 26 are selected for use as bracing posts to form part of a guard rail system and are spaced around the perimeter of the building under construction. At selected locations, the base 20 made in accordance with the invention will be secured to the underlying deck using nails in the case of a wood deck or anchors in the case of a concrete deck. Once secured to the deck, a piece of lumber 26 is inserted into the receiving socket 28 and the locking lever 44 is rotated to bring the notch pin 38 into engagement with the lumber so as to secure the piece of lumber in the socket. When dismantling the guard rail, the lever 44 is rotated in the opposite direction to release the piece of lumber 26. The base member is then released from the deck by removing the anchors 70 or the nails 80 so that the base can be reused at another location on another floor of the building or at another construction site.

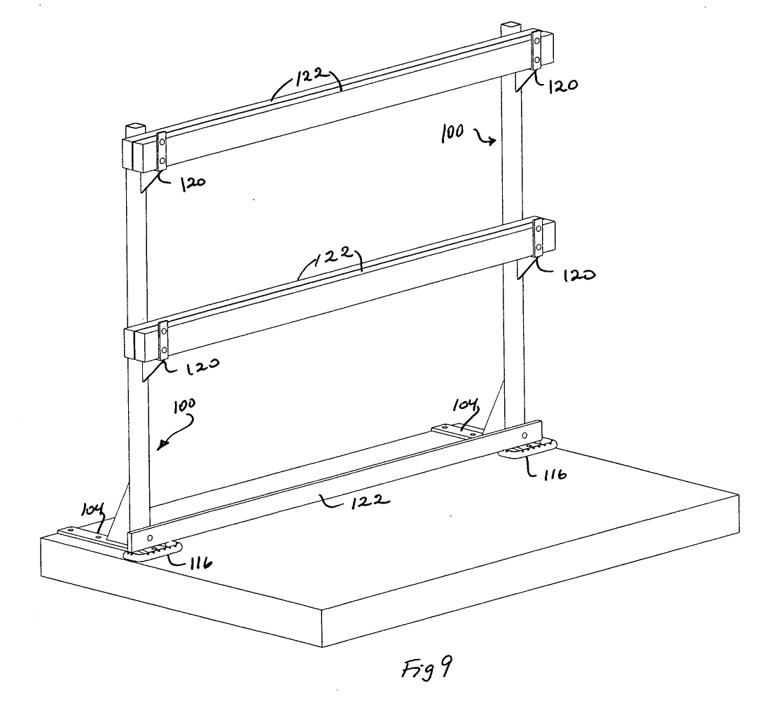

In accordance with another aspect of the invention, there is provided a post generally indicated by reference numeral 100 in FIG. 8 to 10 in which the socket 28 of the first described embodiment is replaced by a longitudinally extending post in the form of a tube 102 having a square cross-section and welded at one end to a base 104 in the form of a plate similar to the base 20 of the first embodiment. The base extends forwardly and rearwardly from opposite sides of the tube 102 to define a rearward wing 106 and a forward wing 108. Each section of the base is apertured with apertures 110 to receive anchors (not shown) for securing the base 104 according to the invention to a concrete deck or alternatively to a plywood underlay 112 as illustrated in FIG. 8. In order to increase the stability and rigidity of the tube 102, a transverse brace 114 extends between the tube 102 and the forward wing 108.

The rearward wing 106 spaces a nail guide identified by reference numeral 116 which is used to secure the base to the plywood underlay 112. The nail guide is in the form of a steel rod bent into a C-shaped configuration and has a plurality of nail guiding apertures spaced from each other along the length of the rod and oriented to receive nails 118 from opposite directions so that the nails may bite into the underlying wood. As in the first described embodiment, the nail guiding apertures are oriented to receive the nails 118 at a preferred angle of 450 to allow the nails to penetrate into the wood and to withstand accidental prying which would loosen the guard rail base 104 from the deck. In some applications, it may be desirable to use other fasteners such as wood screws instead of nails.

The tube 102 defines an integral post with the base 104 for receiving and locating a transversely disposed removable barrier. In the embodiment illustrated, a pair of brackets 120 longitudinally spaced from each other along the length of the tube 102 are provided and the brackets form a U-shaped channel with the body of the tube 102.

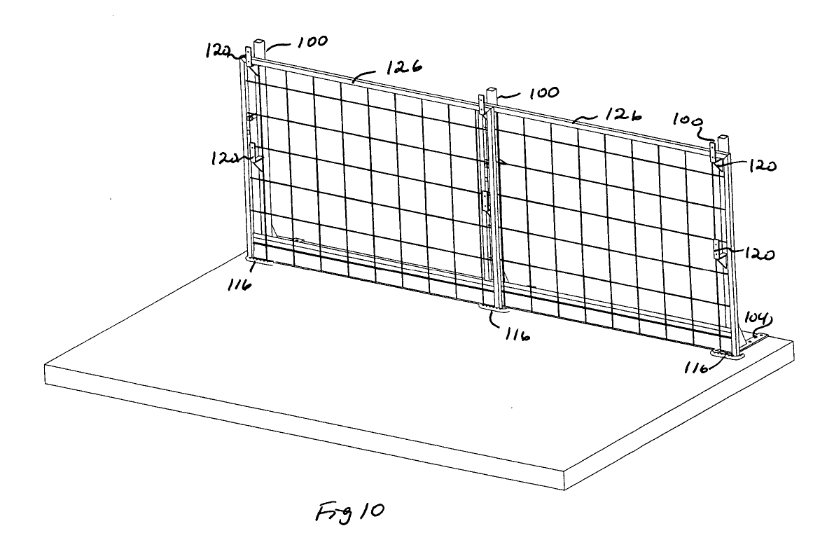

In use, as illustrated by FIG. 9 of the accompanying drawings, lengths of lumber in the form of 2×4's may be disposed transversely between a pair of posts 100 in order to form a removable barrier. It will be noted that the brackets 120 have apertures 124 through which nails may fasten the lumber to the post 100.

Alternatively, the barrier may be defined by a fence panel 126. In the embodiment illustrated in FIG. 10, three posts 100 in accordance with the invention are shown supporting a pair of fence panels 126 between them in an overlapping fashion.

It will be understood that several variations may be made to the above-described preferred embodiment of the invention within the scope of the appended claims.

1. A base for a guard rail system, the base having an open socket dimensioned for receiving a post forming part of the guard rail system and extending from one side of a base member, the base member having apertures for receiving fasteners to secure the base to a support surface, the socket having a transversely extending notch pin rotatably mounted between opposite sides of the socket at one end thereof and adapted to engage the post upon rotation thereof to cut a notch in the post, and a locking lever fixed to the notch pin for rotation of the notch pin into and out of engagement with the post so as to secure the post in the socket and release the post, respectively.

2. A base according to claim 1 in which the notch pin is asynmmetric and has a flat side aligned with an axis of rotation for the notch pin which is adapted to cut a notch into the post upon rotation of the notch pin.

3. A base according to claim 1 in which the base member has a nail guide spaced from the socket, the nail guide having a plurality of nail guiding apertures spaced from each other, the nail guiding apertures being oriented to receive fasteners from opposite directions so that the fasteners may bite into an underlying support surface.

4. A base according to claim 3 in which the nail guide is C-shaped.

5. A base according to claim 3 in which the nail guiding apertures are oriented to receive the fasteners at an angle of 30 to 60 degrees relative to a support surface.

6. A base according to claim 5 in which the nail guiding apertures are oriented to receive the fasteners at an angle of 45 degrees relative to a support surface.

7. A base according to claim 3 in which the base member has a rearward wing defining a spacer for spacing the nail guide from the socket and the spacer is apertured to receive an anchor for securing the base to concrete.

8. A base according to claim 3 in which the base member has a forward wing extending forwardly from the socket on an opposite side from the nail guide, the forward wing being apertured to receive at least one anchor for securing the base to concrete.

9. A base according to claim 1 in which the socket has a closed bottom which is apertured to receive an anchor for securing the base to concrete.

10. A base according to claim 1 in which at least one side of the socket is apertured to allow for visual inspection of the socket and for drainage.

11. A base according to claim 8 in which a transverse brace couples the forward wing to the socket.

12. A post for a guard rail system, the post extending from one side of a base member, and having at least one bracket longitudinally spaced from the base member and adapted to receive and locate a transversely disposed removable barrier, the base member having a nail guide spaced from the post, the nail guide having a plurality of nail guiding apertures spaced from each other, the nail guiding apertures being oriented to receive fasteners from opposite directions so that the fasteners may bite into an underlying support surface.

13. A post according to claim 12 in which the nail guide is C-shaped.

14. A post according to claim 12 in which the nail guiding apertures are oriented to receive fasteners at an angle of 30 to 60 degrees relative to a support surface.

15. A post according to claim 14 in which the nail guiding apertures are oriented to receive fasteners at an angle of 45 degrees relative to a support surface.

16. A post according to claim 12 in which the base member has a rearward wing defining a spacer for spacing the nail guide from the post and the spacer is apertured to receive an anchor for securing the base to concrete.

17. A post according to claim 12 in which the base member has a forward wing extending forwardly from the socket on an opposite side from the nail guide, the forward wing being apertured to receive at least one anchor for securing the base to concrete.

18. A post according to claim 12 having two longitudinally spaced brackets.

19. A post according to claim 12 in which the said at least one bracket forms a U-shaped channel with the post.
